(19) United States
(12) Patent Application Publication
(10) Pub. No.: US 2016/0189537 A1
(43) Pub. Date: Jun. 30, 2016

(54) DEVICE AND METHOD FOR TRANSMITTING REMOTE CONTROL SIGNAL, DEVICE AND METHOD FOR RECEIVING REMOTE CONTROL SIGNAL AND REMOTE CONTROL EQUIPMENT

(71) Applicant: SHANGHAI NINE EAGLES ELECTRONIC TECHNOLOGY CO., LTD., Shanghai (CN)

(72) Inventor: Cheng HUANG, Shanghai (CN)

(73) Assignee: Shanghai Nine Eagles Electronic Technology Co., Ltd., Shanghai (CN)

(21) Appl. No.: 14/892,697

(22) PCT Filed: Apr. 18, 2014
(86) PCT No.: PCT/CN2014/075681

§ 371 Date: Nov. 20, 2015

(30) Foreign Application Priority Data
May 22, 2013 (CN) 201310193041.2

(51) Int. Cl. G08C 17/02

(52) U.S. Cl. CPC G08C 17/02; G08C 2201/71

(57) ABSTRACT

The present invention discloses a device and a method for transmitting a remote control signal, a device and a method for receiving a remote control signal, and remote control equipment. The device for receiving the remote control signal is disposed on a remote control model side and comprises a sensor for determining a current azimuth angle of the remote control model, a receiver for receiving a remote control signal, and a processor for determining manipulation information and azimuth angle information included in the remote control signal; and the azimuth angle information is used for representing the current azimuth angle of a remote control signal transmitting side, and the processor is used for correcting the direction represented by the manipulation information according to the current azimuth angle of the remote control model and the current azimuth angle of the transmitting side and determining the actual movement direction of the remote control model, wherein the actual movement direction is equidirectional with the movement direction represented by the manipulation information. The present invention is available for overcoming the problem that there is a need for a manipulator to judge the direction of the model from the true sense, realizing remote control of an intelligent manipulation mode and improving the experience feeling of a user.

### TECHNICAL FIELD

The present invention relates to the field of remote control models, and in particular to a device and a method for transmitting a remote control signal, a device and a method for receiving a remote control signal, and remote control equipment.

### BACKGROUND ART

The existing background arts regarding the field of remote control models may be described by several parts.

(I) At present, a manipulator controls the movement of a remote control model by manipulating a handle and a control switch of a remote controller to generate a manipulation signal while manipulating the remote control model (such as an aircraft model). Under such manipulation mode, the movement conditions of the remote control models are directly dependent of manipulation skills of the manipulator. The manipulator have to observe carefully, judge accurately, manipulate appropriately and make a respond timely so as to accurately manipulate the remote control models while manipulating the movements (including flying of an aircraft in air, navigation of a ship model in water, traveling of a vehicle model on the land, and the like) of the remote control models, or the conditions, such as collision of the remote control models are easily caused to result in damage of the remote control models.

FIG. 1 is an operational schematic drawing of a common remote controller in the existing technology. In the existing technology, the aircraft model is generally manipulated according to the following steps:

(1) manipulating a handle to move by a manipulator;

(2) generating a manipulation instruction; and

(3) carrying out modulation and then outputting on the manipulation instruction through a high-frequency circuit.

As for a user who is the new to a remote control model, it is greatly difficult to manipulate the remote control model by using a remote controller in the existing technology. For instance, the user needs to take a lot of time to operate the remote controller skillfully for an aircraft model, and in this process, the aircraft model is inevitably to be collided, even damaged. So, time and money of the user are wasted, more importantly, the experience of the user is influenced. Similarly, the same problems, such as great operation difficulty and difficulty to use also exist in manipulation of other types of models.

### (II) Remote Controllers

As always, the remote controllers of multiple models, such as an aircraft model, are just used for transmitting manipulation signals generated by manipulation handles and control switches, and under such remote control manipulation, the movement conditions of the remote control models are directly dependent of the manipulation skills of a manipulator. The manipulator have to observe carefully, judge accurately, manipulate appropriately and make a respond timely so as to accurately manipulate the remote control models while manipulating the movements (including flying of an aircraft in air, navigation of a ship model in water, traveling of a vehicle model on the land, and the like) of the remote control models, or the conditions, such as collision of the remote control models are easily caused to result in damage of the remote control models.

However, as for a user who is the new to a remote control model, it is greatly difficult to remotely control models. For instance, the user needs to take a lot of time to exercise the flight of the aircraft model, for a purpose of realizing correct remote control, and in this process, many aircrafts are inevitable to be damaged by collision, so, time and money of the user are wasted, more importantly, the experience of the user is influenced. Similarly, the same problems, such as great operation difficulty and difficulty to use also exist in remote control of other types of models.

### (III) Manipulation Modes

In the existing technology, the manipulation mode of the aircraft model, for example, refers to a pilot-oriented mode.

The pilot-oriented mode is as follows: after the aircraft model receives a remote control instruction, the movement direction of the aircraft model is executed by assuming that the pilot sits in a cabin of the model according to the direction determined under the orientation of the pilot. Therefore, the pilot-oriented mode can be also called as a “conventional manipulation mode”.

FIG. 2 is a schematic drawing of one condition (the condition that the tail faces to the manipulator) of the pilot-oriented mode. By taking an aileron lever on the remote controller as an example, when the tail of the aircraft model faces to the manipulator, the movement direction of the model is consistent with the manipulation direction of the manipulator.

FIG. 3 is a schematic drawing of another condition (the condition that the head faces to the manipulator) of the pilot-oriented mode. After the model flying in air veers, the condition changes, and as shown in FIG. 3, if the head of the model flies against the manipulator, the aileron lever on the remote controller does left and right manipulations still at this moment, and the movement in the “pilot-oriented” direction is unchanged, however, the movement direction of the model is changed into a reverse direction from the view of the manipulator on the ground.

The change of a push-pull rod manipulation action is the same as the condition of aileron manipulation. After the posture of the aircraft in air changes, the movement direction of the aircraft changes continuously from the view of the manipulator. Therefore, there is a need for the manipulator to accurately judge the aerial posture of the model at any time, however, to achieve this requirement is greatly difficult for a user who is the new to the remote control model, especially to the model in which the head and the tail are not remarkably different (a multi-axis aircraft, for example), and the user is more difficult to identify the direction pointed by the head of the model.

### (IV) Aircrafts

The previous model aircrafts control the flying postures of the aircrafts by passively executing the instructions of manipulators on the ground. At present, some aircrafts are equipped with flight control equipment with inertial systems to increase the stability of the aircrafts, even geomagnetic sensors and GPS systems may be also disposed on the aircrafts to realize an automatic flight return function, but the cost of products and the weight of the aircrafts are greatly increased due to the mounting of these equipment.

### (V) About Headless Mode

In order to avoid the operation difficulty caused by “pilot-oriented”, the existing aircraft is additionally equipped in a sensor for a purpose of realizing so-called “headless mode” flying. But in the existing technology, a direction detection module is carried on a flight control board, and headless mode control can be only achieved on the take-off flight direction at present. However, disorders in front, back, left and right directions will be caused if the aircraft deflects from the take-off flight direction in the flying process. FIG. 4 is a schematic drawing of a “headless mode” when the aircraft model in the existing technology are at the moment of take-off (the assembly drawing on the left side in FIG. 4, wherein the assembly drawing is a combination of the aircraft and the remote controller), at the rotation angle of 90 degrees (the assembly drawing in the middle in FIG. 4) and at the rotation angle of 180 degrees (the assembly drawing on the right side in FIG. 4) respectively, wherein the positions of the head in the aircraft and the longitudinal axis H of the remote controller are marked, and the positions of the head of the aircraft and the longitudinal axis H (the pointing direction of the longitudinal axis may be opposite to that of the longitudinal axis H as shown in FIG. 2) of the remote controller in other drawings in this text are similar, and are thus not described yet.

As shown in the assembly drawing on the left side in FIG. 4, the aircraft records the take-off direction in the take-off process and takes this direction as the flight direction of the aircraft, the assembly drawings in the middle and on the right side in FIG. 4, for instance, are schematic drawings of the aircraft responding to remote control after rotating by 90 degrees and 180 degrees clockwise, the aircraft is always dead ahead in the take-off direction, and at this moment, movement modes of the aircraft responding to the manipulation instructions are as follows: an elevator is pushed forwards and the aircraft flies forwards; the elevator is pulled backwards, and the aircraft flies backwards; the aileron is pushed rightwards and the aircraft flies rightwards, and the aileron is pushed leftwards and the aircraft flies leftwards, thus realizing the headless mode in this flight direction.

FIG. 5 is a schematic drawing of the aircraft operating in correspondence to the remote controller when the aircraft deflects from the take-off direction. As shown in the assembly drawing on the left side in FIG. 5, under the condition that the aircraft deflects from the take-off direction in the flight process, if the manipulator is over against the aircraft, because the aircraft still takes the take-off direction as the flight direction, the frontage of the aircraft becomes the left of the manipulator, and thus the aircraft flies leftwards when an elevator is pushed forwards; the aircraft flies rightwards when the elevator is pulled backwards; the aircraft flies forwards when the aileron is pushed rightwards, and the aircraft flies backwards when the aileron is pushed leftwards; and therefore, the movement directions of the model are disordered, and the flight control operation is complicated instead.

Even worse, as shown in the assembly drawing on the left side in FIG. 5, the aircraft deflects by 180 degrees in the flight process, the frontage of the aircraft will become the back of the manipulator, thus leading to complete reversion of left and right and easily leading to accidents, such as out of control of the aircraft, aircraft explosion and person injuries.

Similarly, the problems, such as difficulty in distinguishing the direction and relatively high manipulation difficulty are also present in other models, except for the aircraft, and an effective solution has not been proposed yet at present for the problems.

### SUMMARY

The problems, such as difficulty in distinguishing the direction and relatively high manipulation difficulty are present in other models, excepting for the aircraft, in related technologies, and the present invention proposes a device and a method for transmitting a remote control signal and a device and a method for receiving a remote control signal and is thus capable of realizing an all-directional “headless manipulation mode” (this manipulation mode is also called as an intelligent manipulation mode in this text) from the true sense, thus reducing the operation difficulty of the remote control model and improving the experience feeling of a user.

The technical solution of the present invention is realized in such a manner: according to one aspect of the present invention, a device for transmitting a remote control signal is provided, and is positioned on the remote controller side.

Said device for transmitting the remote control signal comprises:
a sensor for determining the current azimuth angle of the remote controller;
a generator which is connected to the sensor and used for generating a remote control signal, wherein the remote control signal includes manipulation signal and azimuth angle information representing the azimuth angle; and
a transmitter for transmitting the remote control signal.

Wherein, said sensor is used for measuring the size and the direction of the geomagnetic field of the current position where the remote controller is located, and determining the current azimuth angle of the remote controller according to the measurement result.

In addition, said sensor is a geomagnetic sensor.

Further, the current azimuth angle of the remote controller is an azimuth angle pointed by the longitudinal axis of the remote controller.

Moreover, under the condition that the flight return operation is triggered, the generator generates a flight return signal, and the transmitter transmits the flight return signal.

According to another aspect of the present invention, a device for receiving the remote control signal is provided, and is disposed on the remote control model side.

The receiving device comprises:
a sensor for determining the current azimuth angle of the remote control model;
a receiver for receiving the remote control signal; and
a processor for determining the manipulation information and the azimuth angle information included in the remote control signal, wherein the azimuth angle information is used for representing the current azimuth angle of a remote control signal transmitting side, and in addition, the processor is used for correcting the movement direction included in the manipulation information according to the current azimuth angle of the remote control model and the current azimuth angle of the transmitting side and determining the actual movement direction of the remote control model, wherein the actual movement direction is equidirectional with the movement direction included in the manipulation information.

Wherein, said sensor is used for measuring the size and the direction of the geomagnetic field of the current position where the remote control model is located and determining the current azimuth angle of the remote control model according to the measurement result.

In addition, said sensor is the geomagnetic sensor.

Further, the current azimuth angle of the remote control model is an azimuth angle pointed by the head of the remote control model.

Additionally, in case that the receiver receives the flight return signal, the processor determines the direction towards the transmitting side as the actual movement direction.

Optionally, the processor is also used for regulating the actual movement direction according to the changed azimuth angle under the condition that the change of the azimuth angle of the transmitting side is determined according to the azimuth angle information. According to another aspect of the present invention, a method for transmitting a remote control signal is provided.

The method comprises: determining the current azimuth angle of the remote controller; generating a remote control signal, wherein the remote control signal includes manipulation information and azimuth angle information representing the azimuth angle; and transmitting the remote control signal.

Wherein, the current azimuth angle of the remote controller is determined, comprising: measuring the size and the direction of the geomagnetic field of the current position where the remote controller is located and determining the current azimuth angle of the remote controller according to the measurement result.

In addition, the current azimuth angle of the remote controller refers to an azimuth angle pointed by the longitudinal axis of the remote controller.

Additionally, under the condition the flight return operation is triggered, a flight return signal is generated and is then transmitted.

According to another aspect of the present invention, a method for receiving a remote control signal is provided.

Said method comprises: determining the current azimuth angle of the remote control model; receiving a remote control signal; and determining manipulation information and azimuth angle information included in the remote control signal, wherein the azimuth angle information is used for representing the current azimuth angle of a remote control signal transmitting side, correcting the movement direction included in the manipulation information according to the current azimuth angle of the remote control model and the current azimuth angle of the transitting side and determining the actual movement direction of the remote control model, wherein the actual movement direction is equidirectional with the movement direction included in the manipulation information.

Wherein, the current azimuth angle of the remote control model is determined, comprising: measuring the size and the direction of the geomagnetic field in a current position where the remote control model is located and determining the current azimuth angle of the remote control model according to the measurement result.

Furthermore, the current azimuth angle of the remote control model refers to the azimuth angle pointed by the head of the remote control model.

Additionally, under the condition that a flight return signal is received, the direction towards a transmitting side is determined as the actual movement direction.

Additionally, this method further comprises:

Under the condition that the change of the azimuth angle of the transmitting side is determined according to the azimuth angle information, regulating the actual movement direction according to the changed azimuth angle.

According to another aspect of the present invention, remote control equipment is provided, and the remote control equipment comprises:
a sensor for determining a posture of the remote control equipment and obtaining posture parameters of the posture according to the determined posture;
a generator which is connected to the sensor and used for generating a remote control signal according to the corresponding relationship of the posture parameters, preconfigured posture parameters and a remote control instruction; and
a transmitter which is connected to the generator and is used for transmitting the remote control signal.

Wherein, in a process of determining the posture of the remote control equipment, the sensor is used for acquiring the current posture type of the remote control equipment, measuring the amplitude corresponding to the current posture type of the remote control equipment, and determining posture parameters according to the posture type and the corresponding amplitude.

In addition, the posture types include at least one of the followings:
rolling, pitching and direction deflection; wherein the rolling amplitude is represented by the size of a rolling angle, the pitching amplitude is represented by the size of a pitching angle, and the direction deflection amplitude is represented by a direction angle. Wherein,
rolling of the remote control equipment corresponds to a remote control instruction of an aileron rocker of the remote control equipment;
pitching of the remote control equipment corresponds to a remote control instruction of an elevator of the remote control equipment; and
direction deflection of the remote control equipment corresponds to a remote control instruction of a direction rocker of the remote controller.

Wherein, the sensor includes a geomagnetic sensor and/or an inertial sensor.

In addition, the remote control equipment comprises a remote controller of an electronic aircraft model.

The sensors for determining the azimuth angle are additionally disposed in the remote control model and the remote controller in the present invention, so that the actual movement direction of the model can be determined according to the self azimuth angle of the model and the azimuth angle of the remote controller, the problem that there is a need for a manipulator to judge the direction of the model can be overcome from the true sense, and remote control in an intelligent manipulation mode is realized; or, the posture of the remote control equipment can be also determined in the present invention, the remote control signal is generated according to the corresponding relationship between the posture parameters of the remote control equipment and the remote control instruction so as to control the remote control model, and the problem that control over the remote control model is directly dependent of the operation skills of the manipulator can be overcome to the great degree, so that the remote control model can move according to the wills of the user rather than independently depending on complicated remote control modes, and thus the manipulation difficulty of the model is reduced and the user experience is improved.

### BRIEF DESCRIPTION OF THE ATTACHED DRAWINGS

FIG. 1 is an operational schematic drawing of the remote controller for the aircraft model in the existing technology.

FIG. 2 is a schematic drawing that the model is subjected to remote control in a pilot-oriented mode in the existing technology when the tail faces to the manipulator.

FIG. 3 is a schematic drawing that the model is subjected to remote control in a pilot-oriented mode in the existing technology when the head faces to the manipulator.

FIG. 4 is a comparative schematic drawing of the remote control direction and the movement direction of the “headless mode” aircraft model in the take-off process in the existing technology;

FIG. 5 is a comparative schematic drawing of the remote control direction and the movement direction of the “headless mode” aircraft model deflecting from the take-off direction in the existing technology.

FIG. 6 is a block diagram of the device for transmitting the remote control signal according to the embodiment of the present invention;

FIG. 7 is a flow diagram of a method for transmitting the remote control signal according to the embodiment of the present invention;

FIG. 8 is a block diagram of the device for receiving the remote control signal according to the embodiment of the present invention;

FIG. 9 is a flow diagram of the method for receiving the remote control signal according to the embodiment of the present invention;

FIG. 10 is a flow diagram when the aircraft model is manipulated according to the technical solution of the embodiment of the present invention;

FIG. 11 is an operational schematic drawing of the all-directional headless model (intelligent manipulation mode) according to the embodiment of the present invention in the take-off direction;

FIG. 12 is an operational schematic drawing of the all-directional headless mode (intelligent manipulation mode) according to the embodiment of the present invention while deflecting from the take-off direction.

FIG. 13 is a schematic principle drawing of the method for transmitting manipulation information by the remote controller according to the embodiment of the present invention;

FIG. 14 is a schematic principle drawing when remote control information is received by the remote control model according to the embodiment of the present invention;

FIG. 15 is a schematic principle drawing when the model is remotely controlled by adopting a manipulator-oriented mode;

FIG. 16 is a schematic principle drawing when the model is remotely controlled by adopting a “headless mode”;

FIG. 17 is a block diagram of the remote control equipment according to the embodiment of the present invention;

FIG. 18 is an operational schematic drawing of the remote controller for the aircraft model according to the embodiment of the preset invention; and

FIG. 19 is an operational flow diagram of the remote controller for the aircraft model according to the embodiment of the present invention.

### DETAILED DESCRIPTIONS OF THE PREFERRED EMBODIMENTS

The technical solution in the embodiments of the present invention will be described clearly and completely below in conjunction with the attached drawings in the embodiments of the present invention. Obviously, the described embodiments are just a part of embodiments of the present invention, rather than all of the embodiments. On the basis of the embodiments in the present invention, all the other embodiments, made by common technical skilled in the art, fall into the protection scope of the present invention.

According to the embodiment of the present invention, a device for transmitting a remote control signal is provided, and located on the remote controller side.

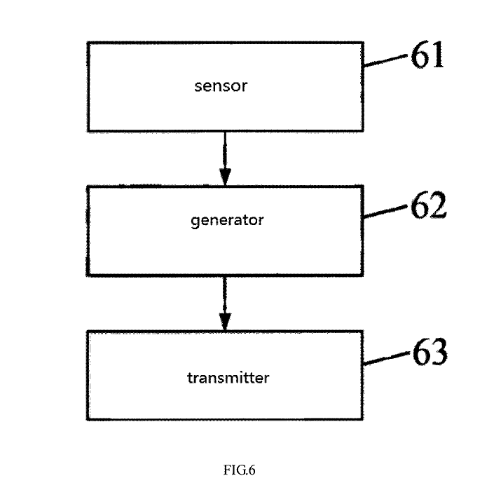

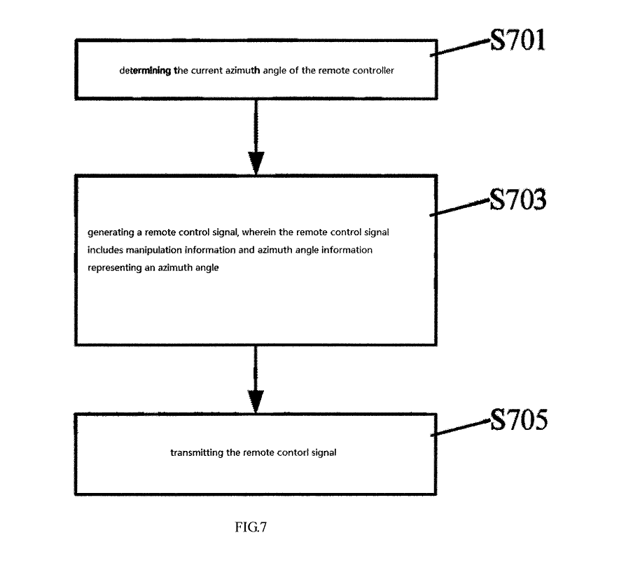

As shown in FIG. 6, the transmitting device according to the embodiment of the present invention may comprise:
a sensor 61 for determining the current azimuth angle of the remote controller;
a generator 62 which is connected to the sensor 61 and is used for generating a remote control signal, wherein the remote control signal includes manipulation information and azimuth angle information representing the azimuth angle; and
a transmitter 63 for transmitting the remote control signal.

Wherein, the sensor 61 may be used for measuring the size and the direction of the geomagnetic field of a current position where the remote controller is located, and determining the current azimuth angle of the remote controller according to the measurement result.

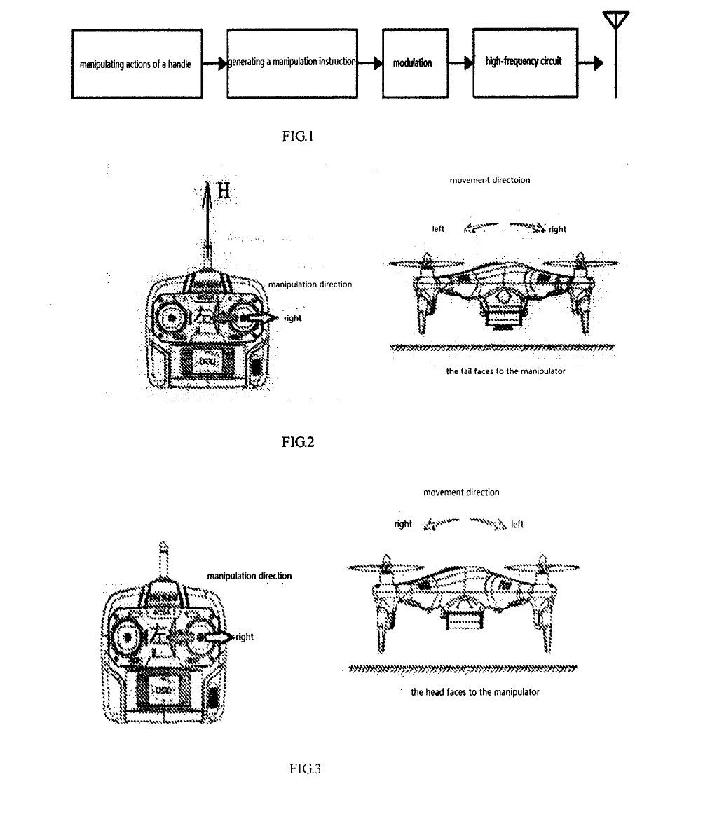

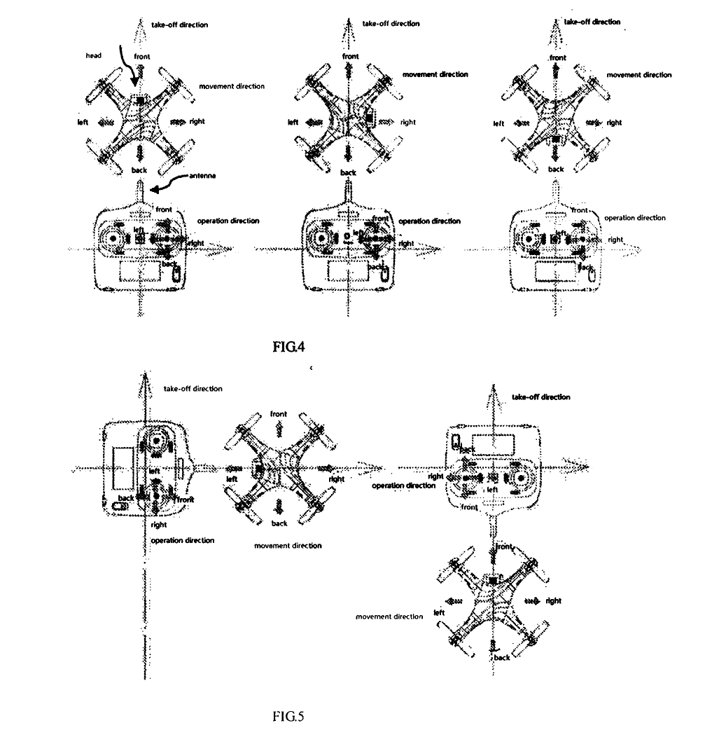

Moreover, the sensor 61 may be a geomagnetic sensor. In addition, the current azimuth angle of the remote controller is an azimuth angle pointed by a longitudinal axis (for instance, may be the longitudinal axis H as shown in FIG. 2 and the direction of which is the pointing direction of the arrow in FIG. 2) of the remote controller. An acceleration meter (configured to correct the azimuth angle) is further additionally disposed in the remote controller and is used for detecting the azimuth angle pointed by the longitudinal axis H of the remote controller in real time. In the form process of the model, the manipulator generally points the longitudinal axis H of the remote controller to the aircraft naturally, and it is thus equivalent to measuring the current azimuth where the aircraft is located.

Additionally, the device for transmitting the remote control signal according to the embodiment of the present invention is also available for realizing automatic flight return of the model. At this moment, in case that the flight return operation is triggered, the generator 62 generates a flight return signal, and the transmitter 63 transmits the flight return signal.

In related technologies, the automatic flight return function may be triggered by means of an automatic flight return key, and when the key is pushed down, the model will automatically return to the manipulator. However, all automatic flight return functions in the related technologies are realized by means of GPS positioning navigation, and GPS is relatively high in cost to cause that many products are incapable of realizing the automatic flight return function.

The automatic flight return function of the model is realized through flight direction correction in combination with the azimuth angle output by the geomagnetic sensor in the remote controller and the remote control model in the embodiment of the present invention, so that GPS devices with high cost are avoided, and thus the cost of the model is reduced.

According to another embodiment of the present invention, a method for transmitting a remote control signal is provided.

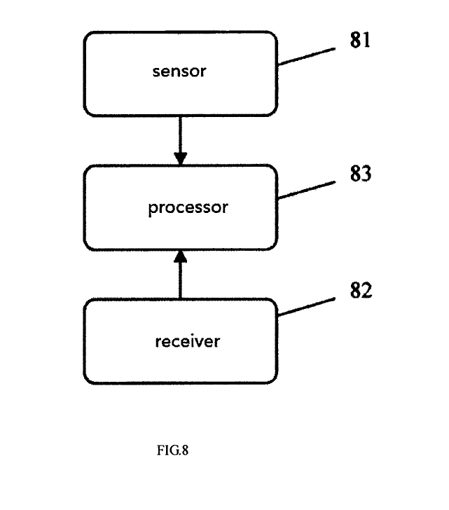

As shown in FIG. 7, the transmitting method according to the embodiment of the present invention may comprise:
S701, determining the current azimuth angle of the remote controller;
S703, generating a remote control signal, wherein the remote control signal includes manipulation information (may comprise direction information for indicating the movement of the remote control model therein) and azimuth information representing the azimuth angle; and
S705, transmitting the remote control signal.

Wherein, the size and the direction of the geomagnetic field of the current position where the remote controller is located can be measured and then determined according to the measurement result when the current azimuth angle of the remote controller is determined.

In addition, the current azimuth angle of the remote controller may be the azimuth direction pointed by the longitudinal axis H of the remote controller.

Furthermore, in case that the flight return operation is triggered, a flight return signal is generated and is then transmitted.

According to another embodiment of the present invention, a device for relieving the remote control signal is provided and is disposed on the remote control model side.

As shown in FIG. 8, the receiving device according to the embodiment of the present invention may comprise:
a sensor 81 which is used for determining the current azimuth angle of the remote control model;
a receiver 82 which is used for receiving a remote control signal, wherein the remote control signal includes manipulation information and azimuth angle information; and
a processor 83 which is used for correcting the movement direction included in the manipulation information according to the current azimuth angle of the remote control model and the current azimuth angle of the transmitting side, and determining the actual movement direction of the remote control model, wherein the actual movement direction is equidirectional with the movement direction included in the manipulation information.

That is to say, because the azimuth angle of the remote control model per se can be judged and the azimuth angle of the remote controller can be also obtained through the remote control signal, the remote control model can obtain the information about movement in which direction and make the movement direction satisfy the movement direction included in an instruction sent by the remote controller in the current direction. Specifically speaking, it is assumed that the remote controller points to the model and sends an instruction of movement towards a first direction, whereas the azimuth angle of the remote control model just points to the first direction at this movement, and therefore, the remote control model will directly move forwards (namely moving along the first direction), so that the movement direction of the remote control model satisfies the movement direction in the instruction sent by the remote controller. Further, it is assumed that the remote control equipment sends manipulation information of moving leftwards, at this moment, no matter what angle that the actual azimuth angle of the remote control model points, because the remote control model knows the self azimuth angle, and meanwhile knows the azimuth angle of the remote controller, the remote control model will make a judgment according to the two azimuth directions to obtain the actual movement direction of the remote control model and further move leftwards from the view of the manipulator. Therefore, by virtue of the technical solution of the present invention, the movement direction of the remote control model is equidirectional with the direction expected by the user of the remote controller, and it is unnecessary for the user to recognize the actual direction of the remote control model, and the remote control model can judge the self movement direction.

Wherein, the sensor 81 is used for measuring the size and the direction of the geomagnetic field of the current position where the remote control model is located and determining the current azimuth angle of the remote control model according to the measurement result. Further, the sensor 81 may be a geomagnetic sensor. The geomagnetic sensor additionally disposed in a flight control board of the model (namely the aircraft) can be configured to measure the size and the direction of the geomagnetic field of the position where the model is located and obtaining the azimuth angle pointed by the head through calculation.

Furthermore, in case that the receiver 82 receives a flight return signal, the processor 83 determines the direction towards the transmitting side as the actual movement direction.

Optionally, the processor can be also configured to regulate the actual movement direction according to the changed azimuth angle under the condition that the change of the azimuth angle of the transmitting side is determined according to the azimuth angle information.

According to another embodiment of the present invention, a method for receiving a remote control signal is provided.

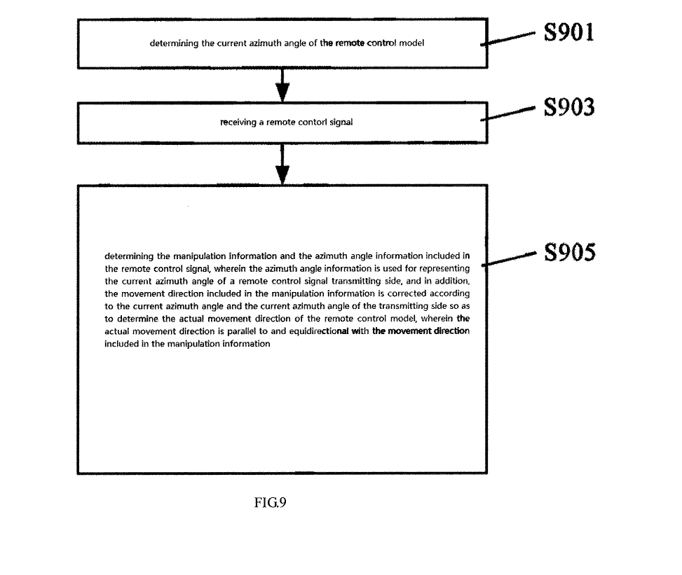

As shown in FIG. 9, the receiving method according to the embodiment of the present invention comprises:
S901, determining the current azimuth angle of the remote control model;
S903, receiving a remote control signal (the remote control signal includes manipulation information and azimuth angle information); and
S905, determining the manipulation information and the azimuth angle information included in the remote control signal, wherein the azimuth angle information is used for representing the current azimuth angle of the remote control signal transmitting side, and moreover, the movement direction included in the manipulation information is corrected according to the current azimuth angle of the remote control model and the current azimuth angle of the transmitting side to determine the actual movement direction of the remote control model, wherein the actual movement direction is equidirectional with the movement direction included in the manipulation information.

Wherein, the size and the direction of the geomagnetic field of the current position where the remote control model is located can be measured by determining the current azimuth angle of the remote control model, and the current azimuth angle of the remote control model is determined according to the measurement result.

In addition, the current azimuth angle of the remote control model refers to the azimuth angle pointed by the head of the remote control model.

Furthermore, in case that a flight return signal is received, the direction towards the transmitting side is determined as the actual movement direction.

In one embodiment of the present invention, automatic flight return is an extension function based on flight direction control, because direction control units of the remote controller and the aircraft could have determined the flight direction in any direction and any state, the aircraft can generate a rudder amount reverse to the direction of the longitudinal axis H of the remote controller after receiving a one-key flight return command, and can thus fly towards the direction of the remote controller, and the manipulator may exit the one-key flight return command by rocking to lift the aileron rocker and recovers the normal operation.

In another embodiment of the present invention, because the flight direction of the aircraft makes reference to the longitudinal axis H of the remote controller under the intelligent manipulation mode, the flight return direction of the aircraft can be also corrected by horizontally rotating the remote controller to change the direction of the remote controller in the flight return process, the transmitter turns left when the aircraft deflects leftwards, and the transmitter turns right when the aircraft deflects rightwards. Additionally, in the traveling process of the remote control model according to other directions, the remote control model can know the changed azimuth angle of the remote controller by regulating the azimuth angle pointed by the remote controller, and thus the current movement direction is regulated. For example, the remote control model travels ahead when the remote controller is over against the remote control model, and if the remote controller is rotated by 15 degrees horizontally leftwards at this moment, the remote control model will travel along the direction of deflecting leftwards by 15 degrees as well.

In the process of realizing the technical solution of the present invention, a reference direction can be designated in advance, and therefore, the respective directions of the remote controller and the remote control model can be determined with the same reference, that is to say, both the azimuth angles of the remote controller and the remote control model can be determined according to the reference direction. Additionally, the reference direction can be artificially set as required, for example, the direction may point to the due north, the due east and the like, and there is no need to enumerate in this text.

FIG. 10 is a flow diagram of a method for manipulating the aircraft according to the technical solution of the present invention, and the specific steps are as follows:
S1001, initializing and then receiving remote control information by the aircraft in a wireless manner;
S1003, judging whether the aircraft takes off or not according to the received remote control information, and if not, executing S1005, and if so, executing S1007;
S1005, aligning at the beginning, calculating an azimuth angle of an antenna of the remote controller and the azimuth angle of the model in a take-off process by using sensors, and returning to S1001 for continuously carrying out next control cycle;
S1007, calculating the rotation angles of the remote controller and the model;
S1009, judging whether the aircraft automatically returns or not, and if not, executing S1007, and if so, executing S1011;
S1011, overlaying a backward rudder amount into a control signal of the aircraft;
S1013, correcting the flight direction of the aircraft, and carrying out control computation;
S1015, controlling output, and returning to S1001 for continuously carrying out next control cycle;
S1017, judging whether being in an intelligent manipulation mode, and if not, executing S1019, and if so, executing S1013; and
S1019, carrying out control computation.

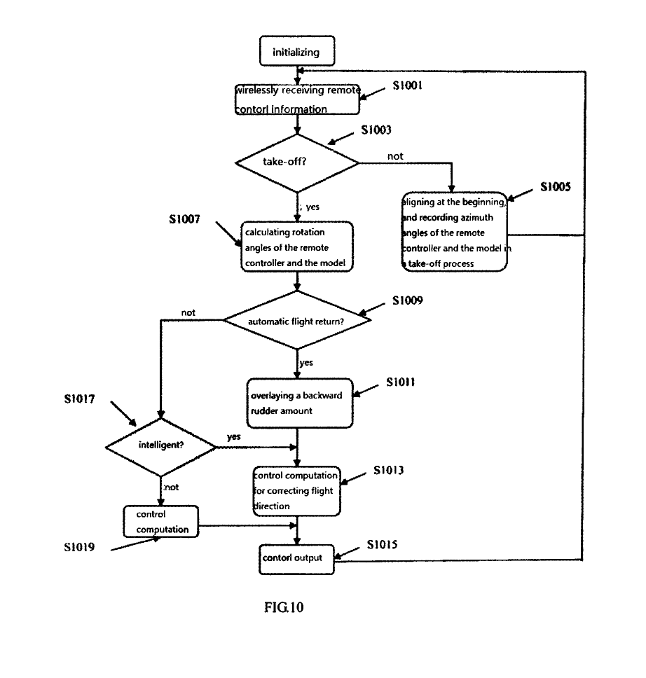

In another embodiment of the present invention, as shown in FIG. 11-a, there is a need to align the remote controller to the flight direction of the model in the take-off process, namely, the antenna of the remote controller points to the tail of the model; as shown in FIG. 11-b and FIG. 11-c, in the flying process, if the direction of the longitudinal axis H of the remote controller is unchanged, and the model rotates by 90 degrees and 180 degrees respectively, and the movement direction of the model is still the same as that of the remote controller; as shown in FIG. 12-a and FIG. 12-b, in the flying process, the model rotates by a certain angle while the remote controller is also rotated by a angle, and the flight direction of the model changes with the rotation of the remote controller, but the direction of the longitudinal axis H of the remote controller is always kept to be the flight direction of the model, and the movement direction of the model is still the same as that of the remote controller; and therefore, the model is capable of realizing a “manipulator-oriented mode” (also called as an “intelligent manipulation mode”) in such a manner.

In the flight process of the aircraft, the remote controller can transmit the self azimuth angle to the receiver through wireless transmission in real time, and the model then corrects the self flight direction according to the change of the azimuth angle of the longitudinal axis H of the remote controller, and always keeps the direction pointed by the longitudinal axis H of the remote controller to be the frontage of the movement.

In the embodiment described above in this text, the azimuth angle of the remote controller may be the azimuth angle pointed by the longitudinal axis H of the remote controller, and actually, in another embodiment, the azimuth angle of the remote controller may be an azimuth angle which is collinear with the longitudinal axis H, but is pointed by a reverse arrow; furthermore, in other embodiments, the azimuth angle of the remote controller may be also the azimuth angle pointed by other components or lines of other angles on the remote controller.

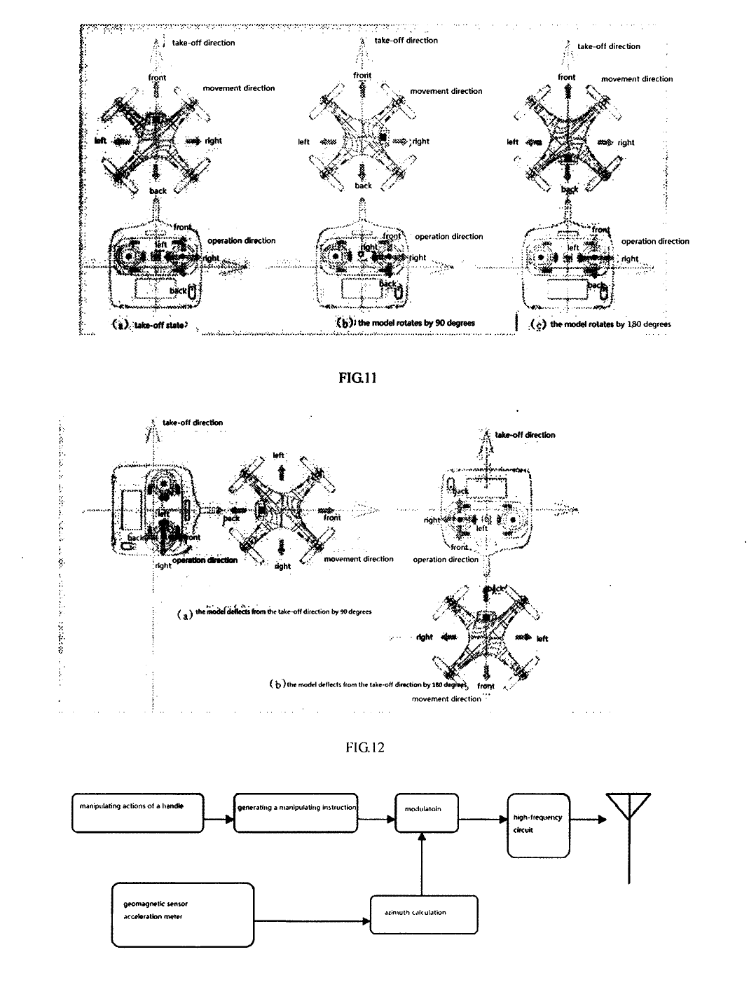

In actual application, the flight direction of the model can be corrected by reference to the following steps. FIG. 13 is a schematic diagram when a flight direction correction command is transmitted to the remote controller (namely an output side).

Step (1) generating a manipulation instruction through manipulating actions of the handle;

Step (2) calculating the current azimuth of the remote controller through the geomagnetic sensor and the acceleration meter to obtain the current azimuth angle of the remote controller; and

Step (3) carrying out modulation on a high-frequency circuit according to the manipulation instruction generated above and the azimuth angle obtained by calculation, and then outputting.

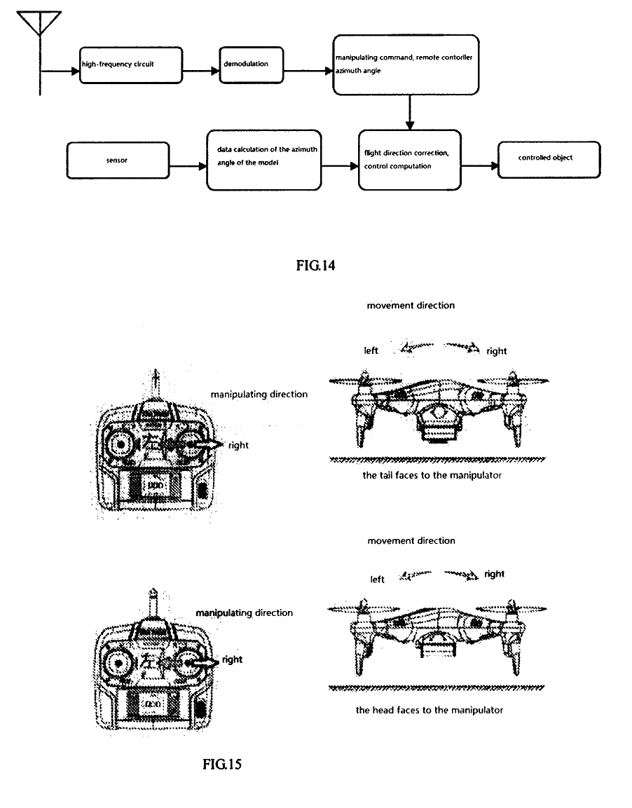

FIG. 14 is a schematic diagram when the aircraft (namely the receiving side) corrects the self flight direction after receiving a correction command of the remote controller.

Step (1) receiving a flight direction correction instruction and then decoding (demodulating) the flight direction correction instruction by the high-frequency circuit, wherein the instruction comprises a manipulation command and a remote control azimuth angle;

Step (2) obtaining the self azimuth angle of the model (namely the aircraft) by the sensor of the aircraft per se through measurement and data calculation;

Step (3) correcting the flight direction of the model according to the flight direction correction instruction in combination with the self azimuth angles of the remote controller and the model; and

Step (4) transmitting the calculation result to a controlled object (namely the aircraft).

As shown in FIG. 15, when the model flies under the manipulator-oriented mode, no matter which azimuth the model is located and where the head of the model points, the model always moves according to the manipulation direction of the manipulator.

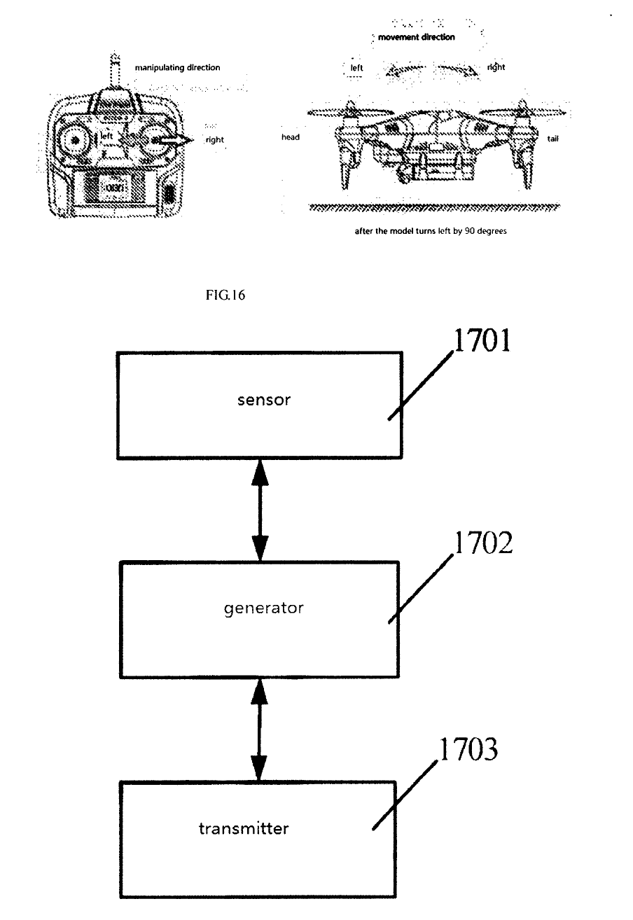

As shown in FIG. 16, in another embodiment of the present invention, after the model rotates by 90 degrees leftwards, the head of the model turns left, and at this moment, when the aileron lever is manipulated leftwards and rightwards, the model still moves leftwards and rightwards from the view of the manipulator. Therefore, it is called as the “manipulator-oriented mode”.

Under the manipulator-oriented mode, there is no need to judge the azimuth of the model and the direction of the head carefully in the flight process, and the lever is moved towards the direction no matter which direction the model is enabled to fly. Since then, there is no a concept of the head, and therefore, the manipulator-oriented mode may be also called as an “all-directional headless manipulation mode” or an “intelligent manipulation mode”.

The technical solution of the present invention may comprise an intelligent manipulation mode and an automatic flight return function of the aircraft model,

Wherein, the intelligent manipulation mode is a manipulator-oriented manipulation mode, and there is no need to judge the azimuth of the model and the direction of the head carefully in the flight process, and the lever is moved towards the direction no matter which direction the model is enabled to fly, and thus the model control is simplified and is more suitable for the new to fly.

Furthermore, the automatic flight return function is available, and the manipulation range of the manipulator is easily drawn back by using an automatic fight return function model if the model is far away from the manipulator.

Similarly, as for the other models, such as ship models and car models, excepting for the aircraft, the movement directions of such types of models may be operated and controlled by using the technical solution of the present invention.

As shown in FIG. 17, the remote control equipment comprises:
a sensor 1701 for determining the posture of the remote control equipment and obtaining posture parameters representing the posture according to the determined posture;
a generator 1702 which is connected to the sensor 1702 and used for generating a remote control signal according to the corresponding relationship of the posture parameters, the preconfigured posture parameters and the remote control instruction; and
a transmitter 1703 which is connected to the generator 1702 and is used for transmitting the remote control signal.

Wherein, in the process of determining the posture of the remote control equipment, the sensor 1701 is also used for obtaining the current posture type of the remote control equipment, measuring the amplitude corresponding to the current posture type of the remote control equipment and determining the posture parameters according to the posture type and the corresponding amplitude.

Wherein, the posture type comprises at least one of the followings: rolling, pitching and direction deflection; wherein the rolling amplitude is represented by the size of a rolling angle, the pitching amplitude can be represented by the size of a pitching angle, and the direction deflection amplitude can be represented by the size of a direction angle.

Wherein, rolling of the remote control equipment may correspond to a remote control instruction of an aileron rocker of the remote control equipment;
pitching of the remote control equipment may correspond to the remote control instruction of an elevator of the remote control equipment; and
deflection direction of the remote control equipment may correspond to a remote control instruction of a direction rocker of the remote controller.

Furthermore, in other embodiment, the posture type of the remote control equipment may also correspond to other types of remote control instructions of the remote control equipment as required, for example, the pitching of the remote control equipment may be also defined to correspond to a remote control instruction for controlling the model to roll.

Wherein, the sensor 1701 comprises a geomagnetic sensor and/or an inertial sensor, and furthermore, the sensor 1701 may also comprise other types or sensors for carrying out posture sensing, or a combination of these sensors. In addition, sensing to different types of postures can be realized by different sensors. In addition, the remote control equipment comprises a remote controller of an electronic aircraft model.

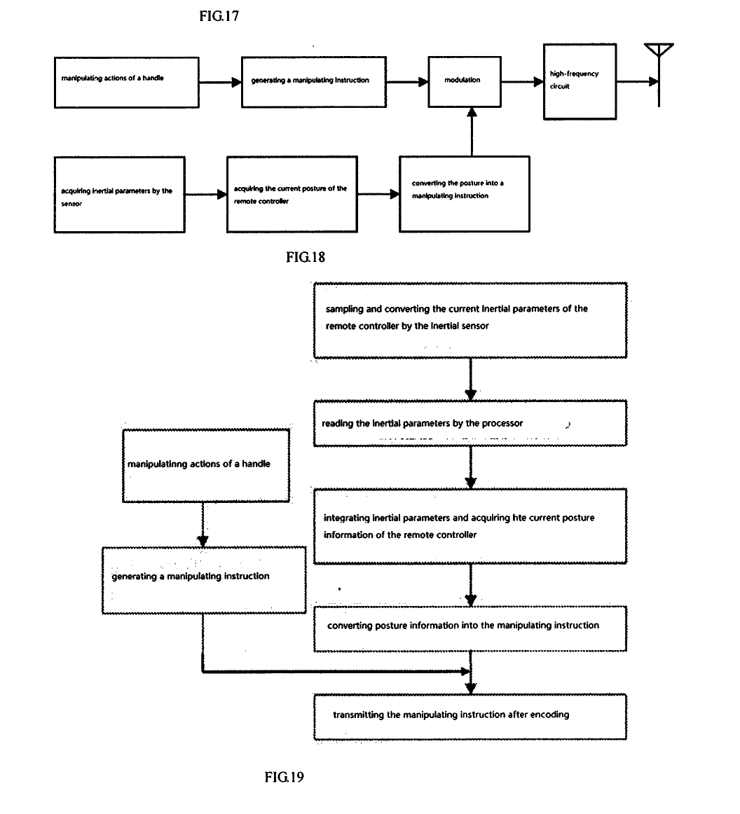

The embodiments of the present invention will be illustrated below by taking the remote controller of the aircraft model as an example. FIG. 18 is an operational schematic drawing of the aircraft remote controller of the embodiment of the present invention. According to the technical solution of the present invention, one or more sensors (the quantity of the sensors is determined according to specific conditions in different embodiments) is or are additionally disposed in the traditional remote controller and used for determining the current inertial parameters (corresponding to the posture parameters, such as rolling, pitching and direction deflection) of the remote controller, and additionally, a processor (equivalent to the generator 1702 in the embodiment aforementioned) is additionally disposed in the present invention, is connected to the inertial sensor and is used for collecting and integrating sensor data, upgrading the current posture of the remote controller to obtain the posture parameters representing the current posture, encoding the preconfigured manipulation information corresponding to the posture parameters into the remote control signal and then transmitting the remote control signal to the receiver (the aircraft model, for instance) in a wireless transmission mode. As shown in FIG. 18, according to the remote control equipment of the embodiment of the present invention, on the one hand, the manipulation instruction can be generated according to the actions of manipulating the handle, and on the other hand, inertial parameters can be acquired by the sensor, the processor can be configured to read the inertial parameters to integrate current posture information of the remote controller obtained according to the inertial parameters, and converting the postures into manipulation instructions (the two functions generating the manipulation instructions can be controlled through devices, such as switches, and are thus activated alternately), and the specific implementation flow can be shown by reference to FIG. 19.

Wherein, the corresponding relationship between the preconfigured posture parameters of the remote controller and the manipulation information may comprise, but is not limited to the following forms, for example, in one example, the rolling posture of the remote controller corresponds to the aileron rocker, namely the action that the remote controller rolls leftwards is equivalent to that the remote controller controls the aileron rocker to shift leftwards, and the action that the remote controller rolls rightwards is equivalent to that the remote controller controls the aileron rocker to shift rightwards, and the rolling amplitude is determined according to the size of the measured rolling angle; in the same way, the pitching posture of the remote controller corresponds to the elevator, and the pitching amplitude is also determined according to the size of the measured pitching angle; and the direction deflection posture of the remote controller corresponds to the direction rocker, and the direction deflection amplitude is determined according to the measured direction angle.

It is easy to understand that rocker-less manipulation can be realized without the need of shifting a rudder through the technical solution described in the embodiments aforementioned, and just is the self posture of the remote controller employed to control the remote control model (control the flight of the aircraft, for example), therefore the operation process is very convenient.

From the above, by means of the technical solution of the present invention, the current azimuth angle of the remote control model can be accurately calculated by additionally disposing the sensor in the remote control model, the actual movement direction of the remote control model is enabled to be equidirectional with the movement direction included in the manipulation information given by the remote controller by receiving the remote control signal and correcting the direction of the remote control model, and therefore the distinguishing degree of the user to the movement direction is increased, the operation difficulty of the remote control model is reduced and experience feeling of the user is improved. According to the technical solution, the flight direction of the aircraft is corrected by using a direction detection module installed in the remote controller so as to realize all-directional headless model control; in addition, automatic flight return can be realized by using the direction detection module installed in the remote controller to correct the flight direction of the aircraft; furthermore, the purpose of rotating the remote controller to correct the flight direction of the aircraft can be realized without the need of shifting the rudder, or, the purpose of manipulating the model without the need of a rocker or rudder shifting is realized by additionally disposing the sensor for detecting the current posture of the remote control equipment, and the generator for generating the remote control signal according to the corresponding relationship of the posture parameters of the remote control equipment, the posture parameters of the remote controller and the remote control instruction in the remote control equipment, and thus the manipulation mode of the remote control model including the aircraft model is greatly simplified, and the user experience is greatly improved.

The embodiments as stated above are just preferred embodiments of the present invention but do not limit the present invention. All amendments, equivalent substitutions, improvements and the like, without departing from the spirit and the principle of the present invention, should fall into the protection scope of the present invention.

1. A device for transmitting a remote control signal, positioned on the remote controller side, comprising:
a sensor configured to determine the current azimuth angle of the remote controller;
a generator which is connected to the sensor and control unit, and configured to generate a remote control signal, wherein the remote control signal include manipulation information and azimuth angle information representing the azimuth angle; and
a transmitter configured to transmit the remote control signal.

2. The transmitting device according to claim 1, wherein the sensor is configured to measure the size and the direction of the geomagnetic field of the current position where the remote controller is located and determine the current azimuth angle of the remote controller according to the measurement result.

3. The transmitting device according to claim 1, wherein the sensor is a geomagnetic sensor and/or an inertial sensor.

4. (canceled)

5. The transmitting device according to claim 1, wherein in case that the flight return operation is triggered, the generator generates a flight return signal, and the transmitter transmits the flight return signal.

6. A device for receiving a remote control signal, configured on the remote control model side, wherein the receiving device comprises:
a sensor configured to determine the current azimuth angle of the remote control model;
a receiver configured to receives a remote control signal; and
a processor configured to determine the manipulation information and the azimuth information angle included in the remote control signal, wherein the azimuth angle information is used for representing the current azimuth angle of a remote control signal transmitting side, and in addition, the processor is configured to correct the movement direction included in the manipulation information according to the current azimuth angle of the remote control model and the current azimuth angle of the transmitting side and determine the actual movement direction of the remote control model, wherein the actual movement direction is equidirectional with the movement direction included in the manipulation information.

7. The receiving device according to claim 6, wherein the sensor is configured to measure the size and the direction of the geomagnetic field of the current position where the remote control model is located, and determine the current azimuth angle of the remote control model according to the measurement result.

8. The receiving device according to claim 6, wherein the sensor is a geomagnetic sensor and/or an inertial sensor.

9. (canceled)

10. The receiving device according to claim 6, wherein under the condition that the receiver is also configured to receive a flight return signal, the processor is configured to determine the direction towards the transmitting side as the actual movement direction.

11. The receiving device according to claim 6, wherein the processor is also configured to regulate the actual movement direction according to the changed azimuth angle under the condition of determining the change of the azimuth angle of the transmitting side according to the azimuth angle information.

12. A method for transmitting a remote control signal, comprising:
determining the current azimuth angle of the remote controller;
generating a remote control signal, wherein the remote control signal includes manipulation information and azimuth angle information representing the azimuth angle; and
transmitting the remote control signal;
wherein the process of determining the current azimuth angle of the remote controller comprises:
measuring the size and the direction of the current position where the remote controller is located, and determining the current azimuth angle of the remote controller according to the measurement result;
wherein in case that flight return operation is triggered, a flight return signal is generated and is then transmitted.

13. The transmitting method according to claim 12, wherein the process of determining the current azimuth angle of the remote controller comprises:
measuring the size and the direction of the current position where the remote controller is located, and determining the current azimuth angle of the remote controller according to the measurement result.

14. (canceled)

15. The transmitting method according to claim 12, wherein in case that flight return operation is triggered, a flight return signal is generated and is then transmitted.

16. A method for receiving a remote control signal, comprising:
determining the current azimuth angle of the remote control model;
receiving a remote control signal; and
determining manipulation information and azimuth angle information included in the remote control signal, wherein the azimuth angle information is used for representing the current azimuth angle of the remote control signal transmitting side, and in addition, the movement direction included in the manipulation information is corrected according to the current azimuth angle of the remote control model and the current azimuth angle of the transmitting side so as to determine the actual movement direction of the remote control model, wherein the actual movement direction is equidirectional with the movement direction included in the manipulation information.

17. The receiving method according to claim 16, wherein the process of determining the current azimuth angle of the remote control model comprises:
measuring the size and the direction of the geomagnetic field of the current position where the remote control model is located, and determining the current azimuth angle of the remote control model according to the measurement result.

18. (canceled)

19. The receiving method according to claim 16, wherein the direction towards the transmitting side is determined as the actual movement direction in case that the flight return signal is received.

20. The receiving method according to claim 16, further comprising:
regulating the actual movement direction according to the changed azimuth angle under the condition of determining the change of the azimuth angle of the transmitting side according to the azimuth angle information.

21. Remote control equipment, comprising:
a sensor configured to determine the posture of the remote control equipment and obtain posture parameters representing the posture according to the determined posture;
a generator which is connected to the sensor and configured to generate a remote control signal according to the corresponding relationship of the posture parameters, preconfigured posture parameters and a remote control instruction; and
a transmitter which is connected to the generator and configured to transmit the remote control signal.

22. The remote control equipment according to claim 21, wherein the sensor is configured to acquire the current posture type of the remote control equipment when determining the posture of the remote control equipment, measure the amplitude corresponding to the current posture type of the remote control equipment and determine the posture parameters according to the posture type and the corresponding amplitude.

23. The remote control equipment according to claim 22, wherein the posture type comprises at least one of the followings:
rolling, pitching and direction deflection; wherein the rolling amplitude is represented by the size of a rolling angle, the pitching amplitude is represented by the size of a pitching angle, and the direction deflection amplitude is represented by the size of a direction angle.

24. The remote control equipment according to claim 23, wherein,
rolling of the remote control equipment corresponds to a remote control instruction of an aileron rocker of the remote control equipment;
pitching of the remote control equipment corresponds to a remote control instruction of an elevator of the remote control equipment; and
direction deflection of the remote control equipment corresponds to a remote control instruction of a direction rocker of the remote controller;

25. The remote control equipment according to claim 21, wherein the sensor comprises a geomagnetic sensor and/or an inertial sensor.

26. The remote control equipment according to claim 21, wherein the remote control equipment is a remote controller of an aircraft model.
